(19) United States
(12) Patent Application Publication
(10) Pub. No.: US 2010/0007877 A1
(43) Pub. Date: Jan. 14, 2010

(54) Narrow-band spectrometric Measurements

(76) Inventors: E. Neil Lewis, Brookeville, MD (US); Linda K. Yarlott, Catonsville, MD (US); Kenneth S. Haber, Frederick, MD (US)

Correspondence Address: KRISTOFER E. ELBING, 187 PELHAM ISLAND ROAD, WAYLAND, MA, 01778, US

(21) Appl. No.: 12/319,817

(22) Filed: Jan. 12, 2009

Related U.S. Application Data
(63) Continuation of application No. 09/788,316, filed on Feb. 16, 2001, now abandoned.
(60) Provisional application No. 60/183,663, filed on Feb. 18, 2000.

(51) Int. Cl. G01J 3/28

(52) U.S. Cl. 356/326

(57) ABSTRACT

Spectrometers and spectrometric measurement methods are disclosed. These employ narrow-band sources positioned in a circular array to perform spectrometric measurements that can employ Hadamard sequences.

### FIELD OF THE INVENTION

This invention relates to spectrometers and spectrometric measurement methods, and more particularly to spectrometers and spectrometric measurement methods that employ narrow-band sources to perform spectrometric measurements, which can employ Hadamard sequences.

### BACKGROUND OF THE INVENTION

Absorption spectrometers allow scientists to quantify the spectral characteristics of materials. These instruments generally include an illumination source, a detector, and a spectrally selective element, such as a grating, a prism, or one or more filters. Light from the source, such as infrared or near infrared light, typically interacts with a sample and is then filtered to leave one or more wavelengths of interest. The detector transduces these wavelengths into an electrical signal that can be processed to yield spectrometric information.

To obtain the best signal-to-noise ratio, large, high-intensity illumination sources are usually used. These sources tend to be expensive, draw large amounts of electrical power, and generate a lot of heat. And even the best of these sources do not provide enough light for optimum spectral measurements in many instances.

### SUMMARY OF THE INVENTION

In one general aspect the invention features a spectrometer that includes a circular array of narrowband illumination sources of a same type positioned around an objective to differently illuminate different parts of a sample surface located in a detection area by directing a plurality of differently directed beams of narrowband light toward the detection area from different illumination source positions surrounding the objective, a detector positioned at a third position opposite the objective from the sample and being responsive to the narrowband light from the different sources reflected off of the different parts of a sample surface in the detection area, wherein the circular array surrounds an optical path from the detection area to the detector, and a spectroscopic signal output responsive to the interaction between the sample and narrowband light from the narrowband illumination sources received by the detector after reflection off of the different parts of the sample surface in the detection area and operative to provide spectral information about chemical properties of the sample surface based on the narrowband illumination from the different beams received by the detector after reflection off of the different parts of the sample surface.

In another general aspect, the invention features a spectrometer that includes an array of illumination sources positioned to illuminate a detection area with a plurality of beams of light. A detector is responsive to the detection area, and a spectroscopic signal output is responsive to relative amounts of light from the beams in different spectral regions received by the detector after interaction with the sample in the detection area.

In preferred embodiments, the spectrometer can further include a switching array having a plurality of switched outputs that are each operatively connected to an input of at least one of the illumination sources. The spectrometer can further include at least a first spectrally selective element having and at least a second spectrally selective element, with the first spectrally selective element having a different spectral response than the second spectrally selective element, with the first spectrally selective element being located in an optical path between the detector and a one of the illumination sources that is operatively connected to a first of the switched outputs and the second spectrally selective element being located in an optical path between the detector and a one of the illumination sources that is operatively connected to a second of the switched outputs. The spectral responses of the spectrally selective elements can correspond to different absorption bands of a predetermined substance. The switching array can be operative to define an intensity level for one or more of the sources. The switching array can be operative to define an intensity level for one or more of the sources by determining an illumination time period for the one of the sources relative to an illumination time period for another of the sources. The spectrometer can further include sequencing logic operative to cause the switching array to switch the sources in a sequence of successive overlapping spatial patterns. The sequencing logic can be operative to cause the switching array to switch the sources in a Hadamard sequence. The spectrometer can further include a plurality of spectrally selective elements having different spectral responses and each being located in an optical path between at least one of the illumination sources and the detector. The spectrally selective elements can be passive. The spectrally selective elements can be reflectors, which can be at least generally parabolic. The reflectors can be at least generally ellipsoidal. The sources can be substantially the same, or they can be of a same type. The spectrometer can be a microscopic instrument, with the sources each producing a luminous flux of at most about 10 millilumens lumens at the detection area. The spectrometer can be a macroscopic instrument, with the sources each producing a luminous flux of at most about 1 lumen at the detection area. The sources can be placed within 2 or even 1 cm of the detection area. The sources can have a nominal supply voltage of twelve volts or less, or even five volts or less. The sources can be broadband sources. The spectrometer can further include a plurality of narrow-band dielectric filter elements each located in a optical output path of at least one of the sources. The sources can be broadband infrared sources. They can be incandescent sources. They can also be narrow-band sources, such as narrow-band infrared sources. The sources can be constructed from bulk semiconductor materials. At least a plurality of the sources can be operatively connected to a single power supply. The illumination sources can be positioned to illuminate different sub-areas of the detection area. At least a first portion of the beams can overlap within the sample area. The detector can be located to receive the beams from the illumination sources after they are reflected off of the sample. The detector can be a multi-element detector array. The spectrometer can further include a circular support for the array, with the detection area being located along a central axis of the circular support. The circular support can surround an optical path from the detection area to the detector. The detector can be part of a microscope. The spectrometer can further include a spectral matching module responsive to the spectroscopic signal output and operative to perform spectral matching operations with one or more known substances. The detector can include a plurality of detector elements, with the detection area being divided into a plurality of detection sub-areas, and with each of the detector elements being aligned with one of the detection sub-areas. The detector can be an array detector that includes at least the detector elements disposed in an array, and the spectrometer can further include a plurality of optical conductors each including first and second ends, wherein each of the first ends is responsive to at least one of the detection sub-areas, and wherein each of the detector elements is responsive to one of the second ends of at least one of the optical conductors. The array can include a plurality of substantially similar illumination sources.

In another general aspect, the invention features a spectrometry method that includes the steps of illuminating a sample with a plurality of beams of light, detecting illumination from the sample resulting from the step of illuminating, and deriving a spectroscopic signal from relative amounts of the light from the beams detected by the step of detecting in different spectral regions.

In preferred embodiments, the step of illuminating can include the step of first illuminating the sample with at least a first of the beams and the step of then illuminating the sample with at least a second of the beams. The method can further include filtering the first plurality of the beams with a first filter characteristic and filtering the second plurality of the beams with a second filter characteristic, with the first and second filter characteristics being different. The steps of illuminating the sample with first and second beams can be performed for different beam energies. The steps of illuminating the sample with first and second beams can be performed for different amounts of time to achieve the different beam energies. The can further include the step of filtering ones of the plurality beams of light according to different filter characteristics. The method can further include the step of concentrating the beams. The step of concentrating can include a step of collimating. The step of concentrating can include a step of focusing. The method can further include the step of matching results of the step of deriving with known spectra. The step of detecting can detect a spatially resolved image and the method can further include the step of evaluating the spatially resolved image to determine composition distribution within at least a portion of the sample. The steps of illuminating, detecting, deriving, and evaluating can be performed for pharmaceutical dosage units. The steps of illuminating, detecting, deriving, and evaluating can be performed for pathology samples. The steps of illuminating, detecting, deriving, and evaluating can be performed for biological tissue. The step of illuminating can employ a plurality of substantially similar beams of light.

In a further general aspect, the invention features a spectrometer that includes means for illuminating a sample with a plurality of beams of light, means for detecting illumination from the sample resulting from the means for illuminating, and means for deriving a spectroscopic signal from relative amounts of the light from the beams detected by the means for detecting in different spectral regions.

In another general aspect, the invention features an optical instrument that includes a plurality of optical conductors each including first and second ends, with each of the first ends being responsive to at least one of the detection sub-areas, and an array detector including a plurality of array detector elements that are each responsive to one of the second ends of one of the optical conductors. In preferred embodiments, the optical conductors can be optical fibers. The array detector can be a two-dimensional array.

In a further general aspect, the invention features an optical method that includes receiving light from a plurality of sample sub-areas, conducting the light received in the step of receiving through a plurality of optically conductive paths, and detecting the light from the optically conductive paths with different detector elements in a detector array.

In another general aspect, the invention features an optical instrument that includes means for receiving light from a plurality of sample sub-areas, means for conducting the light received in the step of receiving through a plurality of optically conductive paths, and detector array means for detecting the light from the optically conductive paths with different detector elements in the detector array.

Systems according to the invention may be beneficial in that they can allow precise control of sample illumination in spectrometric measurements. This is because multi-source arrays can permit the spatial illumination profile generated by the array to be precisely tailored, resulting in even illumination of the sample. And a more even illumination profile can result in a more even temperature profile, which can reduce the risk of damaging the sample. Systems according to the invention can also permit deliberately uneven illumination of the sample in order to emphasize particular features.

Spectrometers according to the invention can be less expensive and safer to use as well. Because the sources in a multi-source arrays are smaller, they can usually be placed closer to the sample, allowing a relatively larger proportion of the radiated illumination to reach the sample. This reduces the amount of energy wasted by the source and the amount of heat generated by the fixture. As a result, instruments according to the invention can be more energy-efficient and less prone to cause fires or burns. Smaller arrays may also be driven by lower voltages, resulting in further energy savings and additional safety. And smaller arrays of sources may allow a designer of a spectrometric system to avoid the use of some optical elements, such as optical fibers, which can be optically inefficient, complicated, and introduce additional cost. The benefits of systems according to the invention may be particularly important in systems that use large array detectors, which require a very high light levels over a large number of detectors.

Additional cost savings may be attributable to source replacement costs. Because of its superior efficiency, an array of smaller sources can be designed to operate at lower temperatures than a single large one, which can result in an extended useful life. And when smaller sources do fail, replacing them is less expensive than replacing a larger source. It may even be possible to build systems with some degree of redundancy, allowing operations to continue even if one or more of the sources fails.

Spectrometers according to the invention can also be more compact and lightweight than conventional spectrometers. This is because multi-source arrays can be physically smaller and placed closer to the sample than an equivalent single source. And because they use less power, they may not require as much surface area to dissipate heat. Systems according to the invention can even by built using integrated circuit fabrication techniques, allowing further miniaturization and energy savings.

Systems according to the invention may also allow for the efficient and/or uniform illumination of a variety of shapes. Because the output of multiple sources can be configured to evenly cover the shape of a sample, spectrometers employing multi-source arrays can maximize the spectral information received from the sample. Adjusting the illumination footprint can also allow spectrometers according to the invention to efficiently and effectively monitor a number of samples at the same time.

Spectrometers according to the invention can allow for switching of filtered sources as well. Spectrometers equipped with switched sources can perform spectrometric measurements reliably, inexpensively, and efficiently because they do not require any moving parts. Such spectrometers can also improve signal-to-noise performance by restricting energy incident on the sample to within a particular wavelength range of interest.

### BRIEF DESCRIPTION OF THE DRAWINGS

FIG. 1 is a block diagram of a spectrometer according to the invention;

FIG. 2 is a perspective diagram of a two-dimensional source array for use in the spectrometer of FIG. 1;

FIG. 3 is a perspective diagram of a linear source array for use in the spectrometer of FIG. 1;

FIG. 4 is a plan view of a circular source array for use in the spectrometer of FIG. 1;

FIG. 5 is a flowchart illustrating the operation of the system of FIG. 5;

FIG. 6 is a diagram illustrating portions of a spectrometer such as the one shown in FIG. 1 that has been adapted to employ light conductors; and

FIG. 7 is another diagram illustrating portions of another spectrometer such as the one shown in FIG. 1 that has been adapted to employ light conductors.

### DETAILED DESCRIPTION OF AN ILLUSTRATIVE EMBODIMENT

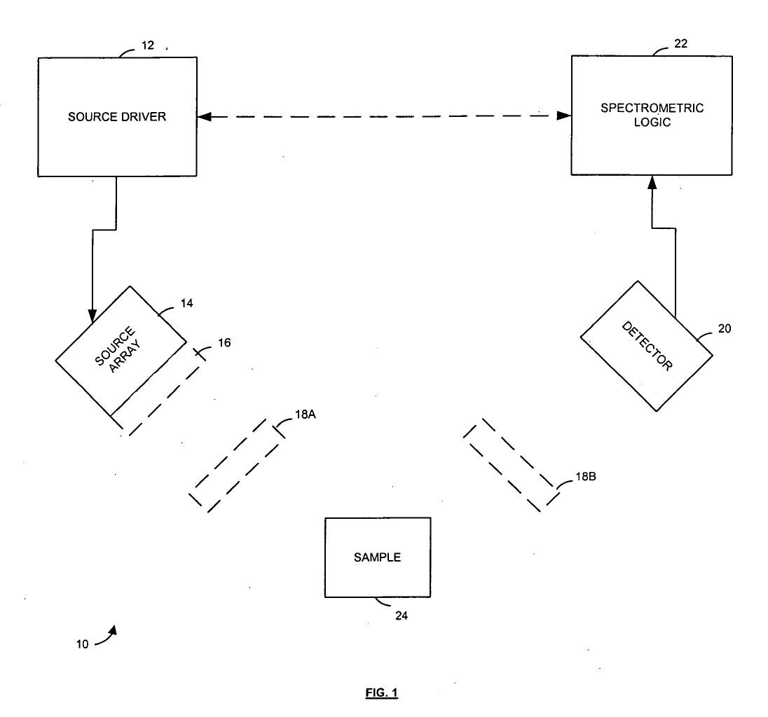

Referring to FIG. 1 a spectrometer 10 according to the invention includes a source driver 12, a source array 14, a detector 20, and spectrometric logic 22. The spectrometer also includes a spectrally selective element 18 that is located in an optical path between the source array and the detector. This spectrally selective element can be located between the array and a sample 24 (position A) or between the sample and the detector (position B).

The source array 14 is a multi-source array. Rather than including a single large source, it includes a number of smaller sources. Each of these sources is preferably separately concentrated onto the sample by individual concentrating elements in a concentrating element array 16. The concentrating element array can include lenses or other transmissive elements placed between the each source and the sample, or it can include mirrors or other reflective elements that can be placed near the sources.

The concentrating element array 16 can operate by collimating and/or focusing light from the sources. The position of the sources themselves may also contribute to maximizing the amount of light incident on the sample. For example, an array of sources can be shaped in a curve to surround the sample.

The shape and luminous output characteristics of the array can be matched to the sample and the detector. They can be configured to distribute light only to parts of the sample that need illumination and in such a way that the light that has interacted with the sample is optimally coupled to the detector. In a multi-well configuration, for example, large areas of the assay plate generally contain no sample and therefore need not be illuminated.

The array can be made up of a number of separate elements or it can be an integrated array. Where separate elements are used, these can be incandescent bulbs, flash lamps, or other types of elements. Integrated arrays can include laser diodes, light emitting diodes (LED's), or other types or elements that are fabricated using semiconductor fabrication techniques or similar methods. Such arrays may also include integrated concentrating elements such as collimating or focusing lenses. In one embodiment, the sources are 5 volt Quartz-Tungsten-Halogen (QTH) sources, such as are available from Gillway, of Woburn, Mass. or Welsh-Allen, of Skaneateles Falls, N.Y.

The source driver 12 can include a power supply, and may also include a switching array that has separately switchable outputs provided to subsets of the lamps in the array. The switching array can be made up of a number of different types of switching elements that switch a power signal or a control signal to the sources, such as transistors, relays, or digital-to-analog converter elements. The switching array can also include optical switching elements that switch the optical output of the sources, such as shutters, tunable filters, or movable mirrors. Embodiments that include switching arrays preferably provide an operative connection between the source driver and the spectrometric logic. For example, control inputs of the switching array can receive switching signals from a control output of the sepectrometric logic 22, or information about the state of the switching array can be provided to the sepectrometric logic.

The detector 20 can be an individual detector or an array detector. Where an array detector is used, the array detector and source array can be configured to achieve two different modes of operation. In the first mode of operation, each detector in the detector array receives overlapping light primarily or exclusively from a corresponding source in the source array. In the second mode of operation, each detector receives light from more than one of the sources in the source array. The two modes are defined by the placement of the array elements and detector elements and the placement and characteristics of the focusing elements.

In one embodiment, the detector is a near-infrared focal plane array detector coupled with a tunable filter. Such a system can be used to monitor chemical properties in a variety of settings, such as in pharmaceutical, agricultural, and polymer industries.

The spectrally selective element 18 can be one of a number of different types of wavelength-dependent optical elements that separate light into spectral components, such as prisms, filters, gratings, or monochromators. It can operate by transmission (e.g., a filter in front of a source array element) or by reflection (e.g., a parabolic or elliptical reflector coated with dielectric material and located around the source array element). The spectrally selective element can be a single element spanning the whole section of the optical path between the source array 14 and the detector 20. It can also be a compound element or set of elements with different sub-elements placed in portions of the optical path between the source array and the detector.

Compound spectrally selective elements or sets of spectrally selective elements can be used in systems with a switching array to create an instrument with selectable spectral content. This can be accomplished by coupling spectrally selective sub-elements with different wavelength selectivities with separately switched source array elements, or groups of elements. Turning on each of these elements or groups of elements in succession will then result in light having different spectral content being shone on the sample. This approach is beneficial when compared with a number of other approaches for achieving variable spectral content, such as filter wheels or adjustable monochromators, in that it does not require any moving parts.

The spectrometric logic 22 receives signals from the detector and extracts and/or presents spectral information from those signals. It preferably includes a spectrometric processor that can perform univariate or multivariate spectral analysis. It may also include simpler analog and/or digital logic. In a process monitoring application, for example, the spectral logic may include a simple circuit that is dedicated to the detection of a particular spectral signature. In a laboratory instrument, on the other hand, the spectral logic may be highly programmable. Note that while the spectrometer shown is designed to measure the spectral content of light reflected through the sample, the optical path can be readily adjusted so that the spectrometer can measure light transmitted through the sample.

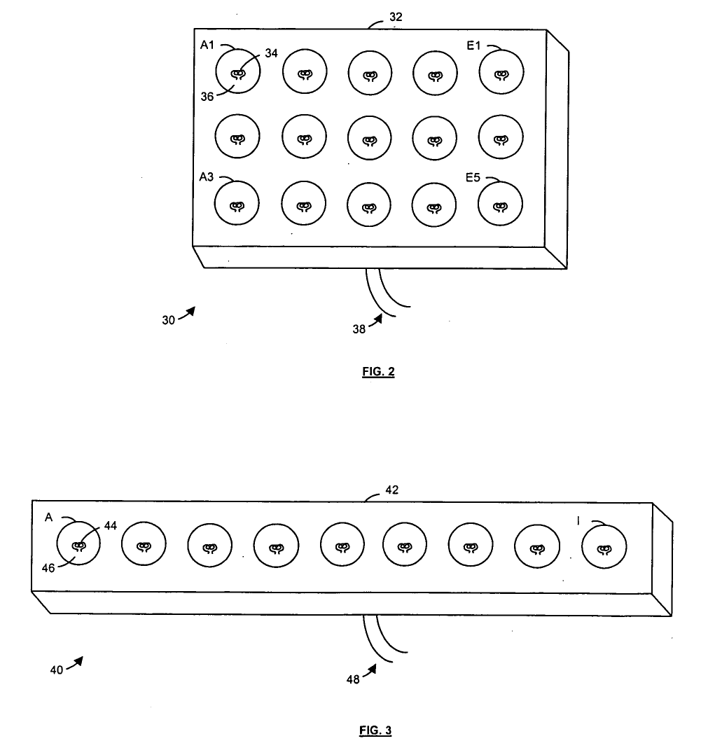

Referring to FIG. 2, a source array 30 can include a rectangular array of small sources A1-A3, B1-B3 . . . E1-E3 held in place by a support structure 32. In the embodiment presented there are 15 sources, but, of course, rectangular arrays having other dimensions can also be constructed. Each source can each include a filament 34 and a reflector 36. Power supply lines 38 can also be connected to the filaments. Where the filaments are to receive power at the same time, they can be connected in parallel or in series, or groups of them may be wired in parallel or in series. Where subsets of the filaments are separately powered, each of these subsets can have their filaments connected to the supply line 38 via a switching element of a switching array.

The location of the sources in the rectangular array 32 can correspond to the location of a number of independent sample areas, or light from the sources can overlap to cover a continuous sample area. In one application, each source can correspond to a vial in a conventional 96-well plate. This type of measurement is described in the above-identified application entitled High-Throughput Infrared Spectrometry.

Referring to FIG. 3, a source array 40 can include a linear array of small sources A-I held in place by a support structure 42. In the embodiment presented there are nine sources, but, of course, linear arrays having other dimensions can also be constructed. Each source can each include a filament 44 and a reflector 46. Power supply lines 48 can also be connected to the filaments, in similar ways to those discussed in connection with FIG. 2.

Linear arrays can be used in process monitoring applications to monitor the surface of a moving process stream. Examples of such types of system are described in the above-referenced application entitled High-Volume On-Line Spectroscopic Composition Testing Of Manufactured Pharmaceutical Dosage Units.

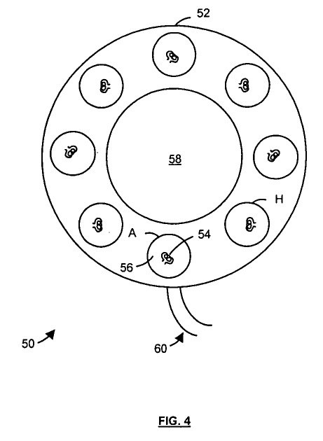

Referring to FIG. 4, a source array 50 can include a circular array of small sources A-H held in place by a support structure 52 that defines an opening 58. In the embodiment presented there are nine sources, but, of course, circular arrays having other dimensions can also be constructed. Each source can include a filament 54 and a reflector 56. Power supply lines 60 can also be connected to the filaments, in similar ways to those discussed in connection with FIG. 2. Circular arrays can be used to provide light in a central area in front of the array, while allowing reflected light to pass through the opening. Such arrays can be used around a microscope objective, for example.

The arrays can be placed quite close to the sample, within a two centimeters of the sample in macroscopic applications and within one centimeter of the sample in microscopic applications. The light contributed by each source is relatively low, such as below one lumen or even 10 millilumens in macroscopic applications, or below 500 lumens or even 100 lumens in macroscopic applications. These characteristics allow for the construction of more compact, effective, and efficient instruments.

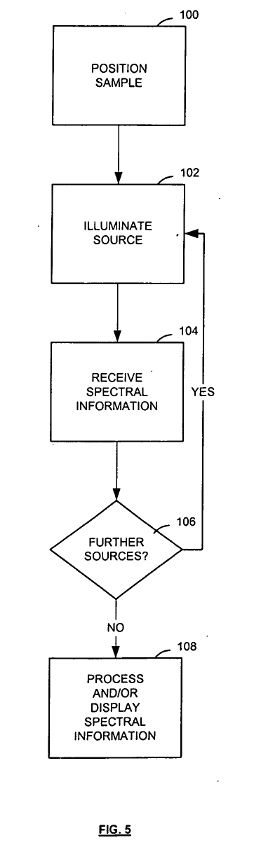

In operation, Referring to FIG. 5, a user of the spectrometer 10 begins by placing a sample 24 in an optical path between the source array 14 and the detector 20 (step 100). Although the source array could be turned on before the placement of the sample, it may be preferable to do so after the sample is in place (step 102). Once the sample is illuminated, the spectrometric logic 22 receives spectral information from the light reflected from the sample (104).

Where the array is configured to illuminate all sources at once, the spectrometric logic 24 can then process and/or display spectral information from the sample (step 108). This operation can include any of a variety of spectrometric manipulations, such as computations intended to identify the composition of a substance, to quantify the amount of a substance, or to map the distribution of a substance. The information resulting from these manipulations can take the form of a number or as a visual representation for viewing by an operator. It can also take the form of an electromagnetic signal to be stored or used in other ways. For example, it may be used as a feedback signal or an alarm signal in process monitoring or diagnostic equipment.

Where the source array is configured with a switching array to illuminate subsets of its sources, the spectrometer successively illuminates and receives spectral information for these subsets (steps 102, 104, 106). For example, where subsets of the source array correspond to spectrally selective elements with different wavelength characteristics, the source array can be switched to successively illuminate the sample with light having different spectral content. This can allow for the extraction of information about several different spectral regions using one or more broadband detectors that only provide a single energy level signal representing the incident energy received within their detection band.

In process monitoring, remote sensing and other applications where there is relative motion between the sources and the sample, the switching array can be switched in synchronism with the relative motion or in synchronism with a fixed standard, such as a camera shutter speed.

The sources can also be switched using sequences such as the Hadamard sequence, as described in provisional application No. 60/091,641, entitled Spectrometry Employing Mirror Arrays and filed Jul. 2, 1998, and its child, application Ser. No. 09/345,672, filed Jun. 30, 1999, as well as application Ser. No. 09/788,316, filed Feb. 16, 2001, all of which are herein incorporated by reference. Such systems can receive an image using a single detector or a smaller array of detectors by illuminating different ones of a series of differently-directed sources according to a suitable sequence of spatial patterns. An unswitched array can also be used in connection with a switchable mirror array, as described in the above-referenced application. A switching sequence can even be designed to derive both spectral and spatial information from the sample with a single detector.

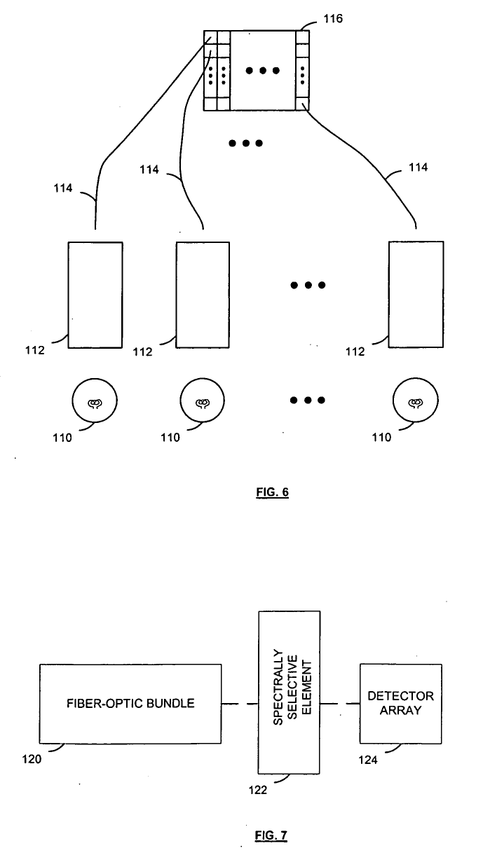

Referring to FIG. 6, optical conductors, such as optical fibers, can also be used to convey detected light in the system to facilitate imaging of widely-spaced sampling areas. In one such embodiment, a number of separate sources 110 each illuminate a target sample in one of a number of separate wells 112. The transmitted light is then collected by one of a number of optical fibers 114 and conducted to individual elements of a detector array 116. This detector array can be a two-dimensional off-the shelf infrared imaging array. Although a one-to-one correspondence between detector elements in the array is possible, each of the fibers can conduct light to one or more of the detector elements, each of the detector elements can receive light from one or more of the fibers, and not all detector elements need to be used to monitor light from a fiber. The spatial mapping between detector elements and vessels can follow an ordered sequence, or it can be random, with the system using a stored map to express the correspondences. The system can even learn the map by itself, by successively illuminating the sources and looking for output signals. This arrangement has the advantage of allowing for inexpensive but reliable detection in a system where the samples are spatially located that is not convenient or possible for conventional imaging optics. It can also allow for a highly versatile instrument that allows its user to easily and safely change the location from which optical information is derived.

Referring to FIG. 7, an embodiment that employs optical conductors can employ a readily available fiber-optic bundle 120. The bundle is unraveled at one end to expose one end of each fiber for placement near the samples. The other end of the bundle can also be unraveled to some degree to expose the other end of each fiber. These exposed fibers can then be organized, such as by being held in a series of lines with clamps, adhesives, or jigs. A spectrally selective element 122 sits between the organized fiber ends and a detector array 124. Note that in this illustrative embodiment, the array preferably has more detector elements than there are fibers in the bundle, so that the fibers do not need to be carefully aligned with particular detector elements.

The present invention has now been described in connection with a number of specific embodiments thereof. However, numerous modifications which are contemplated as falling within the scope of the present invention should now be apparent to those skilled in the art. Therefore, it is intended that the scope of the present invention be limited only by the scope of the claims appended hereto. In addition, the order of presentation of the claims should not be construed to limit the scope of any particular term in the claims.

What is claimed is:

1. A spectrometer, comprising:
a circular array of narrowband illumination sources of a same type positioned around an objective to differently illuminate different parts of a sample surface located in a detection area by directing a plurality of differently directed beams of narrowband light toward the detection area from different illumination source positions surrounding the objective,
a detector positioned at a third position opposite the objective from the sample and being responsive to the narrowband light from the different sources reflected off of the different parts of a sample surface in the detection area, wherein the circular array surrounds an optical path from the detection area to the detector, and
a spectroscopic signal output responsive to the interaction between the sample and narrowband light from the narrowband illumination sources received by the detector after reflection off of the different parts of the sample surface in the detection area and operative to provide spectral information about chemical properties of the sample surface based on the narrowband illumination from the different beams received by the detector after reflection off of the different parts of the sample surface.

2. The apparatus of claim 1 further including at least one reflector located in an optical path between one of the sources and the sample.

3. The apparatus of claim 1 wherein the spectrometric signal output provides a fluorescence-based spectrometric signal.

4. The apparatus of claim 1 further including a switching array having a plurality of switched outputs that are each operatively connected to an input of at least one of the illumination sources.

5. The apparatus of claim 4 wherein the sequencing logic is operative to cause the switching array to switch the sources in a Hadamard sequence.

6. The apparatus of claim 1 wherein the detector is an image detector.

7. The apparatus of claim 1 wherein the circular array includes narrowband sources that have different characteristic wavelengths.

8. The apparatus of claim 1 wherein the spectrometer is a microscopic instrument.

9. The apparatus of claim 1 wherein the spectrometer is a macroscopic instrument.

10. The apparatus of claim 1 further including a plurality of spectrally selective elements having different spectral responses and each being located in an optical path between at least one of the illumination sources and the detector.

11. The apparatus of claim 1 wherein the spectrometer is a microscopic instrument and wherein the sources each produce a luminous flux of at most about 10 millilumens at the detection area.

12. The apparatus of claim 1 further including a spectral matching module responsive to the spectroscopic signal output and operative to perform spectral matching operations with one or more known substances.
